(19) United States
(12) Patent Application Publication
(10) Pub. No.: US 2015/0019645 A1
(43) Pub. Date: Jan. 15, 2015

(54) METHOD AND SYSTEM FOR APPLICATION MESSAGE ALERTING

(71) Applicant: TENCENT TECHNOLOGY (SHENZHEN) COMPANY LIMITED, Shenzhen (CN)

(72) Inventor: YI TANG, Shenzhen (CN)

(73) Assignee: TENCENT TECHNOLOGY (SHENZHEN) COMPANY LIMITED

(21) Appl. No.: 14/462,819

(22) Filed: Aug. 19, 2014

Related U.S. Application Data
(63) Continuation of application No. PCT/CN2014/080291, filed on Jun. 19, 2014.

(30) Foreign Application Priority Data
Jul. 9, 2013 (CN) 201310286590.4

(51) Int. Cl. H04L 29/08

(52) U.S. Cl. CPC H04L 67/20
USPC 709/204

(57) ABSTRACT

An application message alerting method is provided for a terminal. The method includes receiving a third-party application added by a user in a specified browser page, recording a location information of the third-party application in the browser page, and sending a query on the third-party application to a browser server to cause the browser server to obtain update information of the third-party application corresponding to the query from a third-party application server. The method also includes receiving the update information of the third-party application sent by the browser server, and updating a third-party application message alert based on the update information and the location information.

### CROSS-REFERENCES TO RELATED APPLICATIONS

This application is a continuation application of PCT Patent Application No. PCT/CN2014/080291, filed on Jun. 19, 2014, which claims priority of Chinese Patent Application No. 201310286590.4, filed on Jul. 9, 2013, the entire contents of which are incorporated by reference herein.

### FIELD OF THE TECHNOLOGY

The present disclosure generally relates to computer technology field and, more particularly, to an application message alerting method, apparatus, and system.

### BACKGROUND

With the development of web technology, HTML5 standards are more widely used. HTML5 strengthens the multimedia capabilities of the Web page, and adds Web application features such as the local database and so on, providing more standards for enhancing network applications. Therefore, with the development of HTML5 and the performance enhancement of the browser, more and more users choose to replace the original third-party software applications with web-based third-party applications.

Existing third-party software applications typically have a message alert capability, for example, to display a message alert on the application software icon. However, in today's technologies, it is difficult for the web browser messaging applications, such as SNS (Social Networking Services), mail, etc., to achieve the original third-party software application message alert capabilities.

The disclosed methods and systems are directed to solve one or more problems set forth above and other problems.

### BRIEF SUMMARY OF THE DISCLOSURE

One aspect of the present disclosure includes an application message alerting method for a terminal. The method includes receiving a third-party application added by a user in a specified browser page, recording a location information of the third-party application in the browser page, and sending a query on the third-party application to a browser server to cause the browser server to obtain update information of the third-party application corresponding to the query from a third-party application server. The method also includes receiving the update information of the third-party application sent by the browser server, and updating a third-party application message alert based on the update information and the location information.

Another aspect of the present disclosure includes an application message alerting method for a browser server. The method includes receiving a query on a third-party application from a terminal. The query includes terminal identification information, user identification information and third-party application identification information. The method also includes obtaining update information of the third-party application corresponding to the query from a third-party application server based on the third-party application identification information. Further, the method includes sending the update information of the third-party application to the terminal to cause the terminal to update a third-party application message alert based on the update information.

Another aspect of the present disclosure includes an application message alerting system. The system includes a sending unit, a first receiving unit, and an updating unit. The sending unit is configured to send a query on the third-party application to a browser server to cause the browser server to obtain update information of the third-party application corresponding to the query from a third-party application server. The first receiving unit is configured to receive the update information of the third-party application sent by the browser server. Further, the updating unit is configured to update a third-party application message alert based on the update information.

The web applications according to the embodiments of the present invention may obtain a third-party application update information through a browser server, and updates in timely manner the third-party application message alert based on the update information, which achieves the browser-based web application message alerting functions. In addition, by receiving the third-party application update information in real time through a push channel and by performing multiple third-party applications message alerts on the browser default page, the web application according to the embodiments of the present invention allows users to timely and conveniently access the application message alerts.

### BRIEF DESCRIPTION OF THE DRAWINGS

FIG. 1 illustrates a flow chart of an exemplary message alerting method according to disclosed embodiments of the present invention;

FIG. 2 illustrates a flow chart of another exemplary message alerting method according to disclosed embodiments of the present invention;

FIG. 3 illustrates a schematic diagram of an exemplary browser home page according to disclosed embodiments of the present invention;

FIG. 4 illustrates a flow chart of another exemplary message alerting method according to disclosed embodiments of the present invention;

FIG. 5 illustrates a flow chart of another exemplary message alerting method according to disclosed embodiments of the present invention;

FIG. 6 illustrates a flow chart of another exemplary message alerting method according to disclosed embodiments of the present invention;

FIG. 7 illustrates a flow chart of another exemplary message alerting method according to disclosed embodiments of the present invention;

FIG. 8 illustrates a schematic diagram of an exemplary message alerting terminal according to disclosed embodiments of the present invention;

FIG. 9 illustrates a schematic diagram of an exemplary message alerting server according to disclosed embodiments of the present invention;

FIG. 10 illustrates a schematic diagram of an exemplary message alerting system according to disclosed embodiments of the present invention;

FIG. 11 illustrates a schematic block diagram of an exemplary message alerting server according to disclosed embodiments of the present invention; and

FIG. 12 illustrates a schematic block diagram of an exemplary message alerting terminal according to disclosed embodiments of the present invention.

### DETAILED DESCRIPTION

In order to make the above purposes, features and advantages of the present invention more obvious and easy to be understood, the followings, together with accompanying drawings, describe in detail embodiments of the present invention.

Embodiments of the present invention describe from the perspective of realization of an application message alerting apparatus, which can be integrated into a client. The client can be loaded in a terminal, and the terminal can specifically be a smart phone, a tablet PC, an e-book reader, an MP3 (Moving Picture Experts Group Audio Layer III, dynamic image compression standard audio expert level 3) player, an MP4 (Moving Picture Experts Group Audio Layer IV, video compression standard audio expert level 3) player, a portable laptop computer, or a desktop computer, and so on.

Embodiments of the present invention are directed to solve the issues related to the lack of message alert for browser-based web applications in today's technologies. According to the disclosed embodiments, a query is sent to a browser server. Based on the query, the browser server obtains from a third-party application server update information of a third-party application corresponding to the query. Third-party application message alert information can be updated, allowing users to obtain the application message alert in a timely and convenient manner.

Certain terms are used to describe the following embodiments.

QQ: an Internet-based instant messaging (IM) software application.

ANDROID: a Linux-based open source operating system, mainly used in portable devices.

A browser third-party application: the application that is running on a browser over a network and is developed based on web technology to achieve specific functions.

The browser third-party application has certain advantages. First, the browser third-party application is developed using the standard HTML language, which can easily achieve cross-platform compatibility. So mobile application developers no longer need to consider the complexity underlying adaptation and cross-platform development language issues. Second, the browser third-party application can achieve a variety of complex functions, such as LBS features, local data storage, audio and video playback capabilities, and even calling a camera and combining GPU for hardware acceleration. Third, the browser third-party application can be dynamically upgraded as traditional Web sites without the need for the user to download. Fourth, the browser third-party applications can link to each other like the traditional Internet pages and can jump directly from one third-party application to another.

A browser push channel: a message receiving/processing system in a mobile browser to receive and process messages pushed or sent unilaterally by a server or a cloud service.

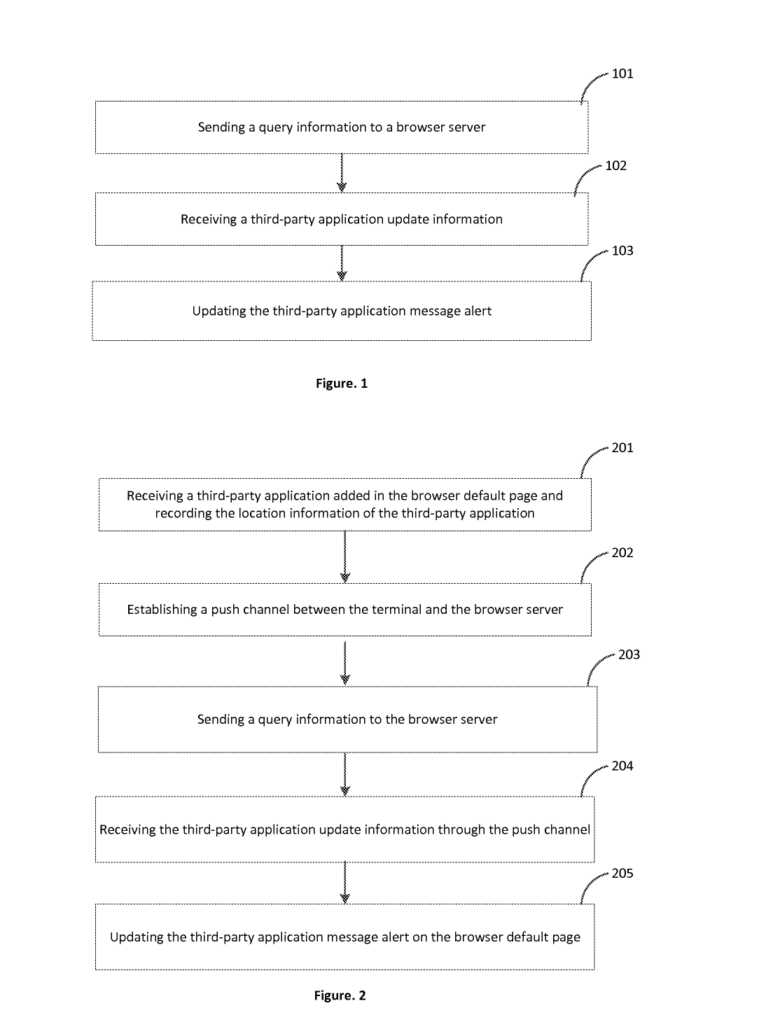

Referring to FIG. 1, an application message alerting method according to disclosed embodiments of the present invention may include the following steps.

At the beginning, in STEP 101, a query is sent to a browser server. The browser server, based on the received query, obtains update information of a third party application corresponding to the query from a third-party application server.

When a user terminal requires third-party application message alerts, the user can turn on an application message alerting function to get the alert messages. When the user uses a third-party web application, a login process may further be included to determine whether the user is logged in. If the user is not logged in, the process goes to a user login screen. After the user logs in successfully, user identification information and third-party application identification information, such as a login ID and a third-party application ID used by the user, can be obtained. When the user uses the third-party web application, the browser can obtain terminal identification information, the user identification information and the third-party application identification information, for example the browser ID, the login ID and the third-party application ID used by the user.

When a browser starts, the browser may send the query to the browser server. The query information may include the terminal identification information, the user identification information and the third-party application identification information, which informs the browser server of the terminal that initiates the query and the to-be-queried third-party application information corresponding to the user identification information. For example, the browser reports the browser ID, the third-party application ID and the user login ID to the browser server.

Based on the query information, the browser server communicates with the third-party application server through open protocols to determine whether the third-party application corresponding to the query has an update. If there is the update, the browser server obtains the update information of the third-party application corresponding to the query. And the browser server may send the update information obtained in real-time to the terminal browser. In addition, the browser can also send the query periodically or when the user configures the third-party application or requests such query.

Further, in STEP 102, the third-party application update information sent by the browser server is received.

Similarly, the update may also include the terminal identification information, the user identification information and the third party application identification information, which can indicate that the update information is corresponding to the query and the received information is the update information of the third-party application corresponding to the query.

Further, in STEP 103, a third-party application message alert is updated.

Specifically, based on the user identification information and the third-party application identification information included in the update information, a location of the corresponding third-party application in the browser home page may be found, and the updated message alert can be displayed at or around the location.

A browser web application according to disclosed embodiments of the present invention may obtain the third-party application update information through the browser server and update the message alert of the web third-party application in a timely manner. Thus, the browser web application achieves the browser-based web application message alerting functionality.

In certain embodiments of the present invention, the application message alerting method may further include: receiving the third-party application added by a user in a default browser page, and recording the location of the third-party application in the browser default page.

In certain embodiments of the method of the present invention, the application message alerting method may also include: establishing a push channel between the browser and the browser server. Receiving the third-party application update information sent by the browser server may further include: receiving the third-party application update information sent by the browser server through the push channel.

As shown in FIG. 2, another application message alerting method according to disclosed embodiments of the present invention may include the following steps.

At the beginning, in STEP 201, a browser receives a third-party application added by a user in a specified browser page, such as a browser default page or a browser home page, and records a location of the third-party application in the specified browser page.

After opening the browser, the user may add the third-party application in a browser setting page. The browser setting page may be a browser home page. For example, the user may add a site icon of a third-party application, such as email, etc., in the browser home page, and records the location information of the third-party application in the browser home page. Thus, the third-party application identification information can be recorded corresponding to its display location in the browser home page.

Further, in STEP 202, the browser establishes a push channel between the browser and the browser server.

The push channel may refer to a message receiving and processing system for the browser terminal to receive and process messages issued by the browser server. Thus, the push channel between the browser and the browser server may be established in advance to receive the third-party application information in real time sent by the browser server.

In STEP 203, the browser sends a query to the browser server. Based on the query, the browser server obtains update information of the third-party application corresponding to the query from a third-party application server.

Since this STEP is similar to STEP 101, the details are not repeated here. Similarly, STEP 203 also needs a login process to determine whether the user is logged in. If the user is not logged in, the process goes to the user login screen. After the user logs in successfully, user identification information and a third-party application identification information can be obtained. According to obtained terminal identification information, the user identification information and the third-party application identification information, the query information is sent to the browser server. In addition, the browser server may obtain the third-party application update information via an open protocol from the third-party application server. For example, the browser server may use the open protocol of HTTP (HyperText Transfer Protocol). Other protocols may also be used.

In STEP 204, the browser receives through the push channel the obtained third-party application update information from the browser server.

In STEP 205, based on the third-party identification information and the location information in the third-party application update information, the browser updates a message alert of the third-party application on the browser default page.

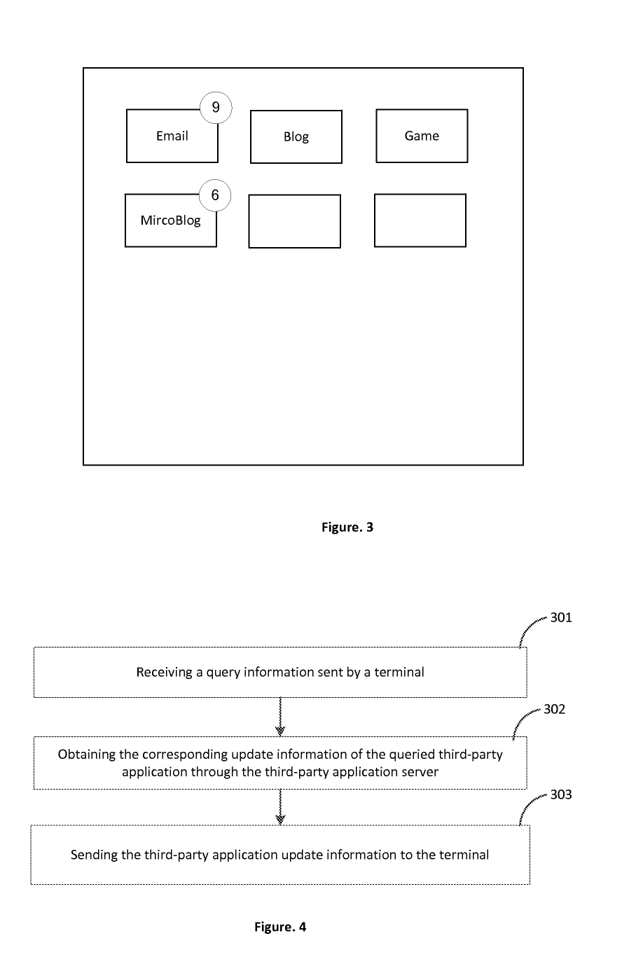

After the browser receives the third-party application update information sent by the browser server, which includes the corresponding third-party application identification information, the browser can find the location of the third-party application in the browser default page (such as the browser home page) and renders the message alert at a predetermined position associated with the third-party application, such as the upper right corner of a third-party application icon. In the schematic diagram of an exemplary browser home page, as shown in FIG. 3, a number at the upper right corner of the third-party application icon may be used to represent the message alerts, for example the number of unread email messages in the mailbox, allowing users to conveniently see different third-party applications message alerts on the browser home page. The number may be displayed within a circle overlapping the right corner of the icon for the third-party application, and the circle may have a different color from the icon or the browser page. Other geometrical shapes, such as triangle, rectangle, square, or other shapes can also be used. For another example, the number of unread microblog messages is also displayed on the right corner of the third-party Microblog application icon in the browser page.

Thus, according to the disclosed embodiments, the terminal receives the third-party application update information in real time via the push channel and display multiple third-party applications message alerts on the browser default page, allowing users to access application message alerts in a timely and convenient manner.

Certain embodiments of the present invention may further be described from the perspective of realization of an application message alert apparatus. The application message alert apparatus may be integrated into an application server implementing the message alert function. The application server which implements the message alert function may be a browser server or a cloud server with terminals connected.

As shown in FIG. 4, another application message alerting method according to disclosed embodiments of the present invention includes the following steps.

At the beginning, in STEP 301, a browser server receives a query from a terminal, wherein the query includes user identification information and third-party application identification information.

When the user terminal needs the third-party application message alert function as requested by a user or by another application program, the application message alerting function can be turned on to get the alert information. When the user uses a third-party web application, a login process may be further included to determine whether the user is logged in the third-party application. If the user is not logged in, the process goes to the user login screen. After the user logs in successfully, the user identification information and the third-party application identification information can be obtained.

The browser server may receive the query information sent by the terminal browser when the terminal browser is started, wherein the query may include terminal identification information, the user identification information and the third-party application identification information. Thus, the browser server may obtain information about the terminal that initiates the query and the to-be-queried third-party application information corresponding to the user identification information. For example, the browser server may obtain an ID of a browser that sends the query, the to-be-queried third-party application ID and the corresponding user login ID.

Further, in STEP 302, the browser server obtains update information of the third-party application corresponding to the query through a third-party application server.

Based on the query, the browser server may be connected to the third-party application server corresponding to the to-be-queried third-party application through an open protocol, and determines through the third-party application server whether the third-party application corresponding to the query has any update. If there is any update, the browser server obtains the update information of the third-party application corresponding to the query. In certain embodiments, the open protocol may be an HTTP (HyperText Transfer Protocol) protocol. The terminal identification information, the user identification information and the third-party application identification information may be included in the update information.

Further, in STEP 303, the browser server sends the third-party application update information to the terminal through a push channel between the terminal and the browser server, so the terminal may present a third-party message alert accordingly.

Based on the update information, the browser server sends the obtained queried third-party application update information corresponding to the user identification information to the terminal browser which initiated the query. The browser server may send the third-party application update information to the terminal through the push channel between the terminal and the browser server established by the terminal. After receiving the update information, the terminal updates the third-party application message alert accordingly. For example, a location of the third-party application in the browser home page can be found, and the message alert can be displayed, for example, at the upper right corner of the third-party application icon.

The browser web application according to disclosed embodiments of the present invention may obtain the third-party application update information through the browser server, and updates the message alert of the web third-party application in a timely manner, thus achieving the browser-based web application message alerting functionality.

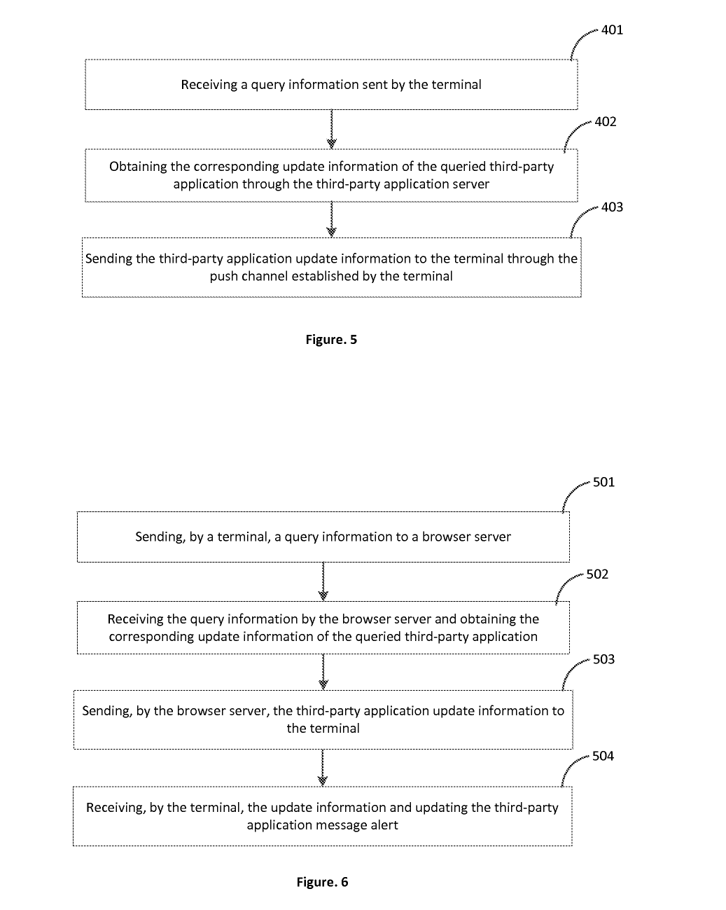

FIG. 5 shows another third-party application message alerting method according to disclosed embodiments of the present invention. As shown in FIG. 5, the message alerting process includes the following steps.

At the beginning, in STEP 401, a browser server receives a query from a terminal, wherein the query includes terminal identification information, user identification information and third-party application identification information.

Further, in STEP 402, the browser server obtains update information of the third-party application corresponding to the query through a third-party application server.

Further, in STEP 403, the browser server sends the third-party application update information to the terminal through a push channel established by the terminal, so the terminal can update a third-party message alert accordingly.

The push channel may refer to a message receiving and processing system for the terminal browser to receive and process messages issued by the browser server. Thus, the browser server may send the third-party application update information to the terminal through the push channel in real time.

Thus, according to the embodiments of the invention, the third-party application update information is sent in real time to the terminal via the push channel between the terminal and the browser server, and multiple third-party applications message alerts can be displayed on the browser default page, allowing users to access to application message alerts in a timely and conveniently manner.

As shown in FIG. 6, another application message alerting method according to disclosed embodiments of the present invention includes the following steps:

At the beginning, in STEP 501, a terminal sends a query to a browser server, wherein the query includes terminal identification information, user identification information and third-party application identification information. For example, the query may include a browser ID, a user login ID and a third-party application ID.

Further, in STEP 502, the browser server receives the query and obtains update information of the third-party application corresponding to the query through a third-party application server.

The browser server may be connected through an open protocol to the third-party application server corresponding to the to-be-queried third-party application to obtain the update information of the third-party application corresponding to the query. In certain embodiments, the update information may include the terminal identification information, the user identification information and the third-party application identification information.

Further, in STEP 503, after obtaining the third-party application update information, the browser server sends the third-party application update information to the terminal.

In certain embodiments, the application message alerting method may further include: establishing a push channel between the terminal and the browser server. Thus, the browser server sending third-party application update information to the terminal may further include: sending the third-party application update information to the terminal through the push channel established by the terminal.

Further, in STEP 504, the terminal receives the update information and updates a third-party application message alert based on the update information.

In certain embodiments of the present invention, the terminal may receive the third-party application added in the browser default page by the user and records a location of the third-party application in the browser default page. Thus, updating the third-party application message alert based on the update information may further include: updating the third-party application message alert on the browser default page based on the third-party application identification information and the location information.

FIG. 7 shows another application message alerting method according to disclosed embodiments of the present invention. As shown in FIG. 7, the message alerting process may include the following steps.

In STEP 601: a terminal receives a third-party application added by a user in the browser default page and records location information of the third-party application in the browser default page.

In STEP 602: the terminal establishes a push channel between the terminal and a browser server.

In STEP 603: the terminal sends a query to the browser server, wherein the query includes terminal identification information, user identification information, and third-party application identification information.

In STEP 604: the browser server receives the query and obtains update information of the third-party application corresponding to the query from a third-party application server.

In STEP 605: the browser server sends the third-party application update information through the push channel established by the terminal to the terminal.

In STEP 606: the terminal receives the update information and updates a third-party application message alert in the browser default page based on the third-party application identification information and the location information.

The embodiments can also be described from the perspective of user terminal interacting with browser server. The browser web application according to disclosed embodiments of the present invention may obtain the third-party application update information through the browser server. Based on the update information, the terminal updates the third-party application message alert in a timely manner. Thus, according to the disclosed embodiments, the browser-based web application message alerting functionality can be realized.

The following uses a mailbox application as an example to illustrate a third-party application use scenario, which briefly describes the application message alerting method according to disclosed embodiments of the present invention.

A terminal may report a browser ID, a mailbox user login ID and a mailbox application ID to a browser server. Meanwhile, a mailbox application may be added in a terminal browser default page (for example a browser home page) and location information of the mailbox application in the browser home page is recorded. The terminal sends a query about any updates on the mailbox application to the browser server. The browser server may then obtain mailbox update information corresponding to the mailbox user login ID from the mailbox application server based on the mailbox application ID.

After obtaining the mailbox application update information from the mailbox application server, the browser server sends the mailbox update information to the terminal through a push channel established by the terminal. After receiving the update information, the terminal updates a mailbox application message alert on the browser home page based on the update information and the location information by, for example displaying a number of unread messages at the upper right corner of a mailbox application icon.

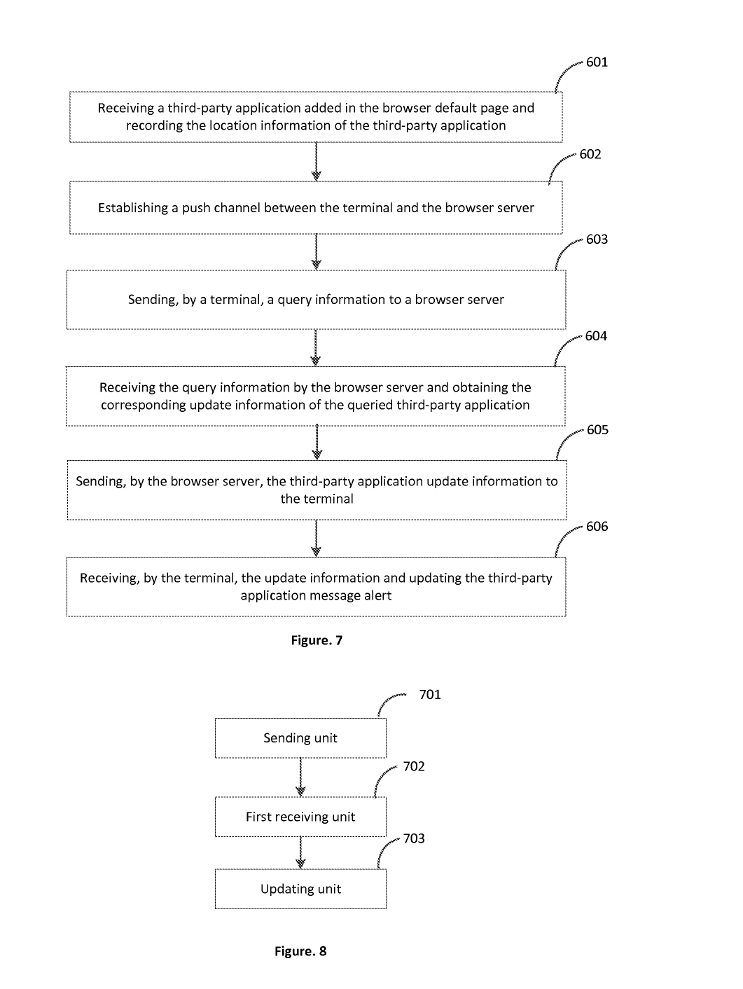

Further, disclosed embodiments of the present invention also provide an application message alerting terminal. As shown in FIG. 8, the application message alerting terminal may include a sending unit 701, a first receiving unit 702, and an updating unit 703.

The sending unit 701 may be configured to send a query to a browser server, thus the browser server may obtain update information of a third-party application corresponding to the query from a third-party application server.

The receiving unit 702 may be configured to receive the third-party application update information sent by the browser server. The updating unit 703 may be configured to update a third-party application message alert based on the update information.

In certain embodiments of the present invention, the update information may include terminal identification information, user identification information and third-party application identification information.

In certain embodiments of the present invention, the application message alerting terminal may further include a second receiving unit and a recording unit (not shown). The second receiving unit may be configured to receive the third-party application added by a user in a browser default page. The recording unit may be configured to record location information of the third-party application in the browser default page.

In certain embodiments of the present invention, the application message alerting terminal may further include an establishing unit (not shown). The establishing unit may be configured to establish a push channel between the terminal and the browser server. Thus, the first receiving unit may also be configured to receive the third-party application update information sent by the browser server through the push channel.

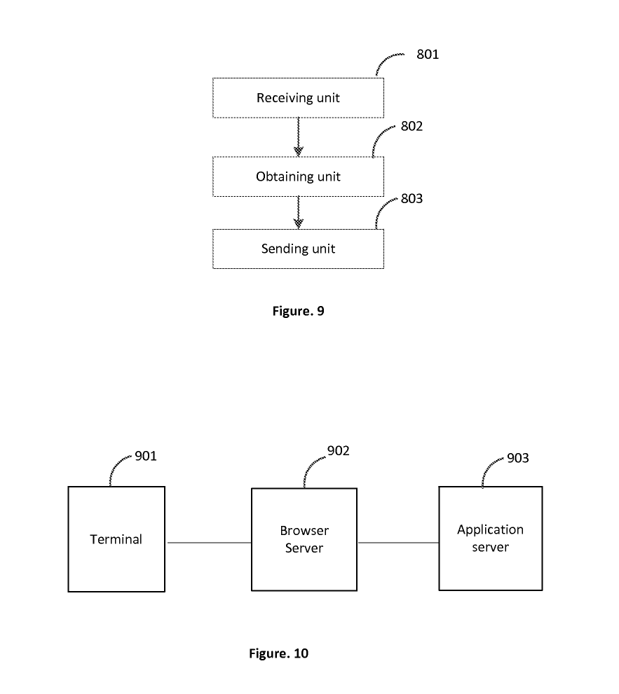

Further, disclosed embodiments of the present invention may also provide an application message alerting server. As shown in FIG. 9, the application message alerting server may include a receiving unit 801, an obtaining unit 802, and a sending unit 803. The receiving unit 801 may be configured to receive a query from a terminal and the query may include terminal identification information, user identification information and third-party application identification information.

The obtaining unit 802 may be configured to obtain the corresponding update information of the queried third-party application through a third-party application server.

Further, the sending unit 802 may be configured to send the third-party application update information to the terminal, so the terminal can update a third-party application message alert based on the update information.

In certain embodiments of the present invention, the update information may include terminal identification information, user identification information, and third-party application identification information.

In certain embodiments of the present invention, the sending unit may further be configured to send the third-party application update information to the terminal through the push channel established by the terminal.

Further, disclosed embodiments of the present invention may also provide an application message alerting system. As shown in FIG. 10, the application message alerting system may include a terminal 901, a browser server 902 and a third-party application server 903.

The terminal 901 may be configured to send a query to the browser server, thus the browser server may obtain the corresponding update information of the queried third-party application from the third-party application server. The terminal 901 may further be configured to receive the third-party application update information issued by the browser server and to update a third-party application message alert based on the update information.

In certain embodiments of the present invention, the terminal 901 may further be configured to receive the third-party application added by a user in a browser home page and to record location information of the third-party application in the browser home page. More specifically, the terminal 901 may be configured to update the third-party application message alert on the browser home page based on the third-party application identification information and the location information.

In certain embodiments, the terminal 901 may further be configured to establish a push channel between the terminal 901 and the browser server 902 and to receive the third-party application update information issued by the browser server 902 via the push channel.

The browser server 902 may be configured to receive the query sent from the terminal 901, wherein the query may include terminal identification information, user identification information and third-party application identification information. And the browser server 902 is further configured to obtain the update information of the third-party application corresponding to the query through the third-party application server 903 and to send the third-party application update information to the terminal 901, thus the terminal 901 can update a third-party application message alert based on the update information.

In certain embodiments of the present invention, the browser server 902 may further send the third-party application update information via the push channel established by the terminal 901 to the terminal 901.

The third-party application server 903 may be configured to obtain the update information of the third-party application corresponding to the query and to send the update information to the browser server 902.

The application message alerting system according to disclosed embodiments may operate as follows.

The terminal receives in advance a third-party application added by a user in a browser default page, records location information of the third-party application in the browser default page, and establishes a push channel between the terminal and a browser server. When the browser starts, the terminal sends a query to the browser server. After receiving the query, the browser server obtains update information of the third-party application corresponding to the query from a third-party application server and sends the third-party application update information to the terminal via the established push channel. The terminal receives the third-party application update information issued by the browser server via the push channel and updates a third-party application message alert on the browser default page based on the third-party application identification information and the location information.

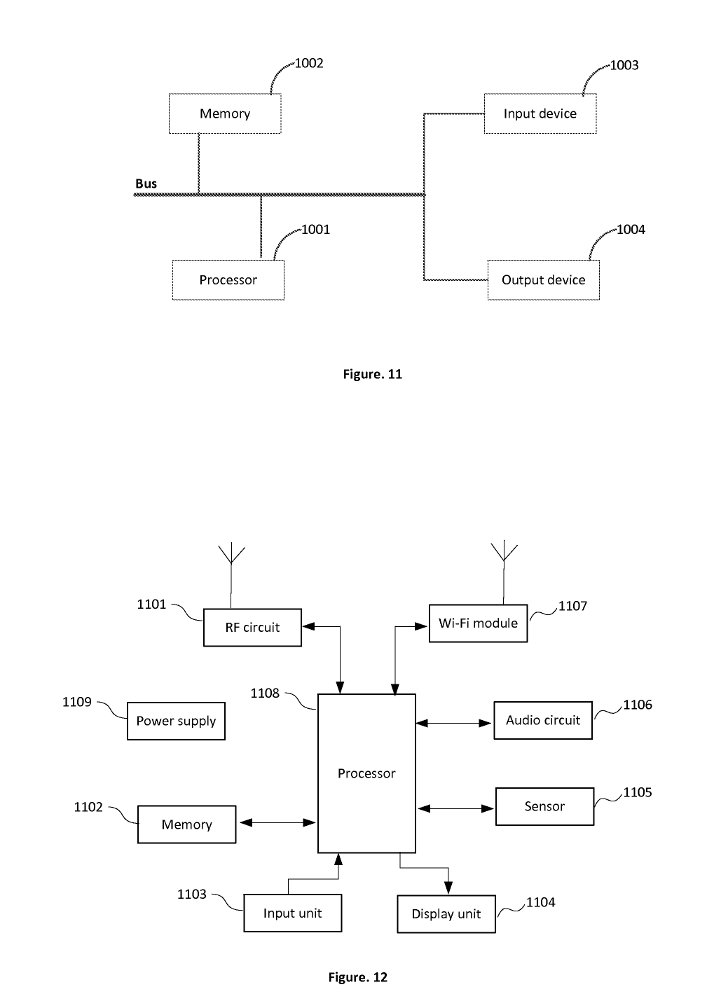

Further, disclosed embodiments of the present invention also provide a browser server. As shown in FIG. 11, the browser server may include a processor 1001, a memory 1002, an input device 1003 and an output device 1004. Other devices may also be included. The browser server may have one or more processors 1001, although one processor is illustrated in FIG. 11 as an example. In certain embodiments of the present invention, the processor 1001, memory 1002, input device 1003 and output device 1004 may be connected via a bus or other means.

The memory 1002 may be configured to store software programs and modules, and the processor 1001 may be configured to perform various functions of a browser server and data processing by running the software programs and modules stored in memory 1002. The memory 1002 may include a program storage segment and a data storage segment, wherein the program storage segment may store an operating system and an application which implements at least one function. In addition, the memory 1002 may include high-speed random access memory. The memory 1002 may also include non-volatile memories, such as at least one disk storage device, flash memory device, or other non-volatile solid-state memory device. The input device 1003 may be used to receive input number and character information and generates the user settings and function-control related key signal input for the browser server.

Specifically, the processor 1001 may follow the following instructions to load one or more executable files corresponding to a process of the application program into memory 1002 and run the application program loaded in the memory 1002 to achieve various functions.

Receiving a query sent by a terminal, wherein the query information may include terminal identification information, user identification information and third-party application identification information.

Obtaining update information of a third-party application corresponding to the query through a third-party application server.

Sending the third-party application update information to the terminal, so the terminal may update the third-party application message alert based on the update information. The update information may include the terminal identification information, the user identification information and the third-party application identification information.

Sending the third-party application update information to the terminal may include: sending the third-party application update information to the terminal through a push channel established by the terminal.

Further, the disclosed embodiments of the present invention may also provide a terminal. As shown in FIG. 12, the terminal may include a RF (Radio Frequency) circuit 1101, one or more computer-readable storage medium 1102, an input unit 1103, a display unit 1104, a sensor 1105, an audio circuit 1106, a Wi-Fi (wireless Fidelity) module 1107, a processor 1108 with one or more processing cores, a power supply 1109 and other components. Those skilled in the art may understand that the terminal structure as shown in FIG. 12 does not constitute any limitation of the terminal, and the terminal may include more or fewer components than those as shown, or a combination of some of the components, or a different arrangement of components.

The RF circuit 1101 may be configured to receive or transmit signals during the receiving and sending of a call or message. In particular, after receiving the downlink information from a base station, the RF circuit 1101 delivers the downlink information to one or more processor 1108. Further, the RF circuit 1101 transmits the uplink data to the base station. In general, the RF circuit 1101 includes, but is not limited to, an antenna, at least one amplifier, a tuner, one or more oscillators, a subscriber identity module (SIM) card, a transceiver, a coupler, a low noise amplifier (LNA), a diplexer, etc. In addition, the RF circuit 1101 may communicate with other devices through wireless communication and a network. Wireless communication may use any communication standards or protocols, including but not limited to global system of mobile communication (GSM), general packet radio service (GPRS), code division multiple access (CDMA), sideband code division multiple access (WCDMA), long term evolution (LTE), email, short messaging service (SMS) and etc.

The memory 1102 is used to store software programs and modules, and the processor 1108 is used to perform various functions and data processing by running the software programs and modules stored in memory 1102. The memory 1102 may mainly include a program storage segment and a data storage segment, wherein the program storage segment may store an operating system and an application which implements at least one function (such as playing audio, playing video, etc.), the data storage segment may store the data created according to the use of the terminal (such as audio data, phone book, etc.). In addition, the memory 1102 may include high-speed random access memory. The memory 1102 may also include non-volatile memory, such as at least one disk storage device, flash memory device, or other non-volatile solid-state memory device. Accordingly, the memory 1102 may also include a memory controller to provide the memory access for the processor 1108 and the input unit 1103.

The input unit 1003 may be used to receive input numbers and character information and generates the user settings and function control related signal input for a keyboard, mouse, joystick, trackball or an optical signal input. Specifically, in one particular embodiment, the input unit 1103 may include a touch sensitive surface and other input devices. Touch sensitive surface, also known as touch screen or touch pad, may collect a user's touching operations on or near it (such as the touching operations of a user's finger, stylus, or any suitable objects on or near the touch-sensitive surface), and drive the corresponding connection device based on a preset program. Alternatively, the touch-sensitive surface may include a touch-detecting device portion and a touch-controller portion. The touch-detecting device detects a user's touching position, detects the signal caused by the touching operation, and sends the signal to the touch controller. The touch controller, after receiving the touching information from the touch-detecting device, converts the touching information into contact coordinates and sends the contact coordinates to the processor 1108. Meanwhile the touch controller may also receive and execute the commands sent by the processor 1108. Further, the touch sensitive surface may also be achieved in various forms, such as resistive, capacitive, infrared and surface acoustic wave, etc. In addition to the touch sensitive surface, the input unit 1103 may also include other input devices. Specifically, other input devices may include, but are not limited to, the physical keyboard, function keys (such as volume control keys, key switches, etc.), a trackball, a mouse, one or more types of operating lever.

The display unit 1104 may be used to display information entered by the user or to display the information provided to the user, and to provide various types of graphic user interface of a terminal. These graphical user interfaces may be constituted in the form of graphics, text, icons, video and any combination thereof. The display unit 1104 may include a display panel, optionally, the display panel may be configured in the form of a LCD (Liquid Crystal Display), an organic light emitting diode (OLED), etc. Further, the touch sensitive surface may cover the display panel. When the touch sensitive surface detects a touching operation on or near it, the touch sensitive surface sends a touch event to the processor 1108 to determine the type of the touch event. Then the processor 1108 provides the corresponding visual output on the display panel according to the type of the touch event. Although, in FIG. 12, the touch sensitive surface and the display panel are shown as two separate components to achieve the input and output function, in some embodiments, the touch sensitive surface may be integrated with the display panel to realize the input and output function.

The terminal may also include at least one sensor 1105, such as light sensor, motion sensor and other sensors. Specifically, the light sensor may include an ambient light sensor and a proximity sensor, wherein the ambient light sensor may be used to adjust the brightness of the display panel according to the ambient light magnitude and the proximity sensor may be configured to turn off the display panel and/or the backlight when the terminal is moved close to the ear. As a motion sensor, the gravity acceleration sensor may detect the acceleration magnitude on all directions (typically in three axes) and may also detect the magnitude and the direction of gravity when in still mode. So the gravity acceleration sensor may be used in phone gesture-identifying applications (such as horizontal and vertical screen switch, relevant games, magnetometer posture calibration), vibration recognition related functions (such as pedometers, percussion), etc. As the terminal may also be configured with gyroscope, barometer, hygrometer, thermometer, infrared sensor and other sensors, the list can go on and no more description is given on this hereafter.

The audio circuit 1106, a speaker, a microphone may provide audio interface between a user and the terminal. On one aspect, the audio circuit 1106, after converting the received audio data into electrical signal, transmits the electrical signal to the speaker and the speaker converts the electrical signal into sound output. On another aspect, after the microphone converts the collected sound signal into electrical signal, the audio circuit 1106 converts the received electrical signal into audio data and transmits audio data to the processor 1108 to be processed. The processed audio data is transmitted through the RF circuit 1101 to for example another terminal or to be stored in the memory 1102 for further processing. The audio circuit 1106 may also include an earplug jack to provide communications between a peripheral headset and the terminal.

Wi-Fi belongs to a short-range wireless transmission technology. The terminal may help a user to send and receive email, browse web page and access streaming media, etc., through the Wi-Fi module 1107. It provides the user with wireless broadband Internet access. Although the Wi-Fi module 1107 is shown in FIG. 12, it is understood that it is not necessarily part of the terminal and can be omitted according to the need in the scope of not changing the nature of the invention.

The processor 1108 is the control center of the terminal. By using a variety of interfaces and circuits to connect various parts of the entire mobile phone, running or executing the software programs and/or modules stored in the memory 1102, and by calling the data stored in the memory 1102, the processor 1108 may perform a variety of functions and data processing of the terminal, so as to monitor the entire mobile phone. Alternatively, the processor 1108 may include one or more processing cores. Preferably, the processor 1108 may be integrated with an application processor and a modem processor, wherein the application processor mainly processes operating system, user interface and applications, etc., and the modem processor mainly handles the wireless communication. It is understandable that the above modem processor may also not be integrated into the processor 1108.

The terminal further includes a power supply 1109 (such as battery). Preferably, the power supply 1109 may be logically connected to the processor 1108 through a power management system. So the functions such as charge, discharge and power management, etc., may be implemented through the power management system. The power supply 1109 may also include one or more of DC or AC power, a recharging system, a power failure detaching circuit, a power converter or inverter, power supply status indictors, etc.

Although not shown, the terminal may also include a camera, a Bluetooth module, etc., the list is not repeated hereafter. In this particular embodiment, the processor 1108 of the terminal follows the following commands to load one or more executable files corresponding to a process of an application program into the memory 1102 and run the application program loaded in the memory 1102 to achieve various functions.

Sending a query to a browser server, so the browser server can obtain update information of a third-party application corresponding to the query through a third-party application server.

Receiving the third-party application update information issued by the browser server.

Updating a third-party application message alert according to the update information. The update information may include terminal identification information, user identification information and the third-party application identification information.

Receiving the third-party application added by the user in a browser default page.

Recording the location information of the third-party application in the browser default page.

Updating the third-party application message alert according to the update information includes:

According to the third-party application identification information and the location information, updating the third-party application message alert on the browser default page.

Establishing a push channel between the terminal and the browser server.

Receiving the third-party application update information issued by the browser server includes receiving the third-party application update information issued by the browser server through the push channel.

Thus, the web application according to disclosed embodiments of the present invention may obtain the third-party application update information through the browser server, and updates in timely manner the third-party application message alert based on the update information, which achieves the browser-based web application message alerting functions. In addition, by receiving the third-party application update information in real time through the push channel and by performing multiple third-party applications message alerts on the browser default page, the web application according to disclosed embodiments of the present invention allows users to access the application message alerts in a timely and conveniently manner.

It should be noted that, various embodiments of the present invention may be described in incremental approach. The description of each embodiment may illustrate the differences from other embodiments, the same or similar portions of various embodiments may refer to each other. Regarding the disclosed system or apparatus of the embodiments, because the disclosed system or apparatus corresponds to the disclosed method, the description is relatively simple and where relevant may refer to the method description.

It should also be noted that, as used in this disclosure, the relational terms, such as “first” and “second”, or the like is only used to distinguish an entity or operation from another entity or operation, it may not necessarily imply any actual relationship or any such order among these entities or operations. Moreover, the terms “comprises,” “comprising,” or any other variation thereof, are intended to cover a non-exclusive inclusion, such that a series of elements including the process, method, article or device not only includes the elements included, but also includes those elements not expressly listed, and further includes the inherent elements of these process, method, article or device. Without more constraints, an element defined by the statement “includes one . . . ” does not exclude the existence of additional identical elements in the process, method, article, or apparatus.

The disclosed methods or algorithm steps may be embodied in hardware, software modules executed by the processor, or a combination of both. The software module can reside in RAM memory, flash memory, ROM memory, EPROM memory, EEPROM memory, registers, hard disk, removable disk, the CD-ROM, or any other form of storage medium known in the field.

The purpose of the above description of disclosed embodiments is to make those skilled in the field to realize or apply the present invention. For those skilled in the field, various modifications to the embodiments of the present invention are obvious. Without departing from the scope or spirit of the present invention, the general principle defined in the present invention may be implemented in other embodiments. Therefore, the present invention is not limited to the embodiments described above, but to conform to the principles and new features disclosed in the descriptions above to the widest possible range.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems for the web application message alerting, the third-party application update information can be obtained through the browser server, and the third-party application message alert can be updated in timely manner based on the update information, which achieves the browser-based web application message alerting functions. In addition, by receiving the third-party application update information in real time through the push channel and by performing multiple third-party applications message alerts on the browser default page, the web application according to disclosed embodiments of the present invention allows users to access the application message alerts in a timely and conveniently manner.

What is claimed is:

1. An application message alerting method for a terminal, comprising:
receiving, by the terminal, a third-party application added by a user in a specified browser page;
recording, by the terminal, location information of the third-party application in the browser page;
sending, by the terminal, a query on the third-party application to a browser server to cause the browser server to obtain update information of the third-party application corresponding to the query from a third-party application server;
receiving, by the terminal, the update information of the third-party application sent by the browser server; and
updating, by the terminal, a third-party application message alert based on the update information and the location information.

2. The method according to claim 1, wherein the update information includes terminal identification information, user identification information, and third-party application identification information.

3. The method according to claim 2, wherein the specified browser page is a browser default page.

4. The method according to claim 3, wherein updating the third-party application message alert includes:
updating the third-party application message alert on the specified browser page according to the third-party application identification information and the location information.

5. The method according to claim 4, wherein updating the third-party application message alert further includes:
displaying the third-party application message alert at a right corner of an icon representing the third-party application on the specified browser page.

6. The method according to claim 4, wherein the displaying further includes:
displaying the third-party application message alert at a right corner of an icon representing the third-party application on the specified browser page.

7. The method according to claim 2, wherein the displaying further includes:
determining whether the user is logged in;
when the user is not logged in, starting a user login screen for the user to log in; and
based on information entered by the user through the user login screen, obtaining the user identification information and third-party application identification information.

8. The method according to claim 1, further comprising:
establishing a push channel between a terminal and the browser server,
wherein receiving the third-party application update information sent by the browser server further includes receiving the third-party application update information sent by the browser server through the push channel.

9. An application message alerting method for a browser server, comprising:
receiving, by the browser server, a query on a third-party application from a terminal, wherein the query includes terminal identification information, user identification information and third-party application identification information;
obtaining, by the browser server, update information of the third-party application corresponding to the query from a third-party application server based on the third-party application identification information; and
sending, by the browser, the update information of the third-party application to the terminal to cause the terminal to update a third-party application message alert based on the update information.

10. The method according to claim 9, wherein the update information includes the terminal identification information, the user identification information and the third-party application information.

11. The method according to claim 10, wherein obtaining the update information further includes:
based on the user identification information and the third-party application identification information, requesting the third-party application server for the update information using an open protocol.

12. The method according to claim 9, wherein sending the third-party application update information to the terminal includes:
sending the third-party application update information to the terminal through a push channel between the browser server and the terminal and established by the terminal.

13. An application message alerting system, comprising:
a sending unit configured to send a query on the third-party application to a browser server to cause the browser server to obtain update information of the third-party application corresponding to the query from a third-party application server;
a first receiving unit configured to receive the update information of the third-party application sent by the browser server;
an updating unit configured to update a third-party application message alert based on the update information.

14. The system according to claim 13, wherein the update information includes terminal identification information, user identification information, and third-party application identification information.

15. The system according to claim 13, further comprising:
a second receiving unit configured to receive the third-party application added by a user in a specified browser page; and
a recording unit configured to record location information of the third-party application in the specified browser page.

16. The system according to claim 15, wherein the updating unit is further configured to update the third-party application message alert on the specified browser page according to the third-party application identification information and the location information.

17. The system according to claim 16, further comprising:
an establishing unit configured to establish a push channel between the terminal and the browser server; and
the first receiving unit is further configured to receive the third-party application update information issued by the browser server through the push channel.

18. The system according to claim 17, wherein the sending unit is further configured to send the third-party application update information to the first receiving unit through the push channel established by the establishing unit.

19. The system according to claim 13, further comprising:
a server receiving unit configured to receive the query sent by the sending unit, wherein the query information includes terminal identification information, user identification information, and third-party application information;
an obtaining unit configured to obtain the update information of the third-party application corresponding to the query through the third-party application server;
a sending unit configured to send the third-party application update information to the first receiving unit such that the updating unit updates the third-part application message alert based on the update information.
